(19) United States
(12) Patent Application Publication
(10) Pub. No.: US 2002/0128862 A1
(43) Pub. Date: Sep. 12, 2002

(54) Data representation management in a database

(75) Inventors: Lee Min Lau, Salt Lake City, UT (US); Brian J. Larsen, Salt Lake City, UT (US); Shane Beeney, Sandy, UT (US); Joni D. Endo, Salt Lake City, UT (US); Matt Landheim, Kaysville, UT (US); Patricia S. Wilson, Henderson, NV (US); Eric C. Lie, Park City, UT (US); Susan Harada, Salt Lake City, UT (US); Martha J. Gerard, Salt Lake City, UT (US); Edward M. Cassin, East Layton, UT (US); Jerry Pay, Sandy, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: 3M Innovative Properties Company

(21) Appl. No.: 09/755,972

(22) Filed: Jan. 5, 2001

(51) Int. Cl. G06F 17/60

(52) U.S. Cl. 705/2

(57) ABSTRACT

Systems and methods for managing physical location data and representation data in a health data dictionary. Clinical data is represented in a health data dictionary using a vocabulary that includes concepts and representations. Each concept is a unique item or idea and each concept can be associated with multiple representations. The default representations are difficult to use because most legacy systems are already accustomed to other terms or identifiers. The present invention allows the representations in the health data dictionary to be changed, altered, or modified according to the desires, of the legacy systems. The representation to be changed is identified by the legacy system and changed in accordance with instructions received from the legacy systems. The instructions may be to update, change, add, delete or otherwise modify a representation. The location manager is used to modify physical location data including representations, contexts, and concepts. The representation manager is used to modify contexts and representations of multiple types of data. In this manner, representations can be searched, assigned to other concepts, updated, changed, deleted, created and the like. The modules that perform these actions are subject to rules and constraints of the health data dictionary. Also, these modules modify relationships in the health data dictionary that are associated with the representations being changed.

### BACKGROUND OF THE INVENTION

1. The Field of the Invention

The present invention relates to databases and to systems and methods for managing data in a database. More particularly, the present invention relates to systems and methods for managing data representations included in a health data dictionary database.

2. Description of Related Art

Computer based patient records (CPRs) are medical histories containing clinical data that can be stored and accessed electronically. Even though CPRs are accessible over computer systems and networks, the medical community is still faced with the problem of processing and evaluating CPRs because the clinical data is often not normalized and the CPRs may have different data formats. While electronically storing data is advantageous, storing data that is not normalized or properly arranged can introduce inconsistencies and incompatibilities that significantly limit the usability of databases storing CPRs.

The difficulties associated with processing and evaluating CPRs begin with the organization and accessibility of the clinical data stored in the CPRs, which is often provided by a variety of different sources, such as laboratory systems, pharmaceutical systems, and hospital information systems. Because the clinical data comes from diverse sources, it is not surprising that the clinical data exists in different formats. International Classification of Diseases (ICD), Systematized Nomenclature of Medicine (SNOMED), Systemized Nomenclature of Pathology (SNOP), commercial systems, and other proprietary formats are examples of systems or formats used when creating and storing medical records such as CPRs. Clinical data or CPRs is often accessed by clinicians, administrators, and researchers, as well as for other reasons including regulatory requirements and statistical studies. Accessing clinical data that is not normalized and is stored in different formats or vocabularies makes the clinical data less usable. For these reasons, accessing clinical data can be a lengthy and unfruitful process.

In order to integrate and normalize the clinical data that is received from various legacy systems and in various vocabularies, a data dictionary is needed to help translate and normalize the clinical data. The data dictionary is effectively a medical database that should have a defined, controlled vocabulary that is able to identify and represent unique items or concepts. The data dictionary should also have a data structure that describes the relationships between concepts such that significant medical descriptions and relationships can be produced. A data dictionary meeting these requirements would be able to translate and normalize medical data regardless of the source of the data and the format of the data.

While the attributes of an ideal data dictionary are identifiable, creating such a dictionary is much more problematic. A significant challenge is developing a vocabulary that is capable of handling both syntactic and semantic constructions. This is particularly important with regard to medical data, which is often expressed in natural language rather than numbers.

An early attempt to develop a data dictionary was through the use, of structured text, which is still in use in many systems. Structured text relies on a model that defines the order in which data will appear. For example, a model laboratory result can be expressed as: [patient], [test], [result name], [result value], and [units]. Structured text works relatively well for predictable data, but has significant disadvantages. A system using structured text to store clinical data does not perform any evaluation on the clinical data that is stored. As a result, misspellings and incorrect entries can easily occur. In addition, any application that is designed to effectively access the structured text must be aware of all possible data variations. This limitation is extremely difficult to overcome because the dictionary storing the structured text as well as the applications accessing the structured text must be modified every time new information, such as lab tests or new drugs, are added to the structured text. Structured text systems also have difficulty dealing with complex data, such as microbiology reports, and are not able to handle a controlled and standardized vocabulary that can be shared with other providers.

Another vocabulary used in data dictionaries is ICD, which emphasizes semantics. ICD uses a three digit number for representing the general concept, followed by a two digit number that represents a specific concept. While the ICD vocabulary facilitates data storage and retrieval, ICD is not adequate for representing the clinical information that is stored in data dictionaries and ultimately, in CPRs. For example, ICD cannot effectively represent time, which is a key element in many medical events. ICD also has the disadvantage of using a single code or concept to represent multiple events. For example, the ICD code of 100.89, “Other Leptospiral Infection,” is used for at least three fevers and three infections. For this reason, ICD introduces ambiguity that should be avoided in the context of a data dictionary.

SNOMED is a coding system or nomenclature that attends to both semantics and syntax. In fact, SNOMED III is a complete vocabulary that enables practitioners to describe a great number of concepts found in CPRs. SNOMED can describe anatomical and temporal concepts as well as probabilities. In spite of these strengths, however, SNOMED does not provide a syntax that is capable of reflecting complex relationships. SNOMED is a substantially complete list of terms that does not clarify the relationships that exist among those terms.

The information that is ultimately stored in a CPR extends beyond the medical realm to include information related to areas such as demographics and insurance. This type of information presents problems similar to the problems presented by medical vocabularies because different systems use different representations for a single concept. For example, the name of an insurance carrier can be represented in several different ways by different legacy systems. A properly designed data dictionary, therefore can assist the storage of patient related data by providing a vocabulary for other data in addition to medical data.

In the dictionary, data is represented in some form. The actual representation of the data in the data dictionary may not be convenient for particular facilities for various reasons. Physical location data, for example, presents certain problems because no two providers are exactly alike. In other words, the organization of nursing divisions, rooms, beds, etc., is typically different for different facilities. Many facilities, such as hospitals, receive donations from time to time that result in name changes. For example, a new wing of a hospital is often named to honor a particular person or organization. Because these physical locations are referred to by their names, it would be an advance in the art if the data dictionary were capable of using names that are specific to a given facility.

At a more basic level, each facility or enterprise typically has beds, rooms, and the like just like every other facility. The difficulty faced in this situation is allowing each separate facility to interact with a data dictionary such that the physical location data of each facility is accurately represented in the data dictionary. Generally stated, the problem associated with data representations is essentially twofold. Requiring each facility to conform to a particular representation is not a good idea because each facility does not mesh well with a standard or default representation. Conversely, altering the data representations in the data dictionary for each separate facility will undoubtedly introduce ambiguity and inconsistencies into the data dictionary.

This problem can be extended generally to other types of data within the data dictionary. Each enterprise typically prefers to represent certain concepts in a way that may be different from other enterprises. Often, these representations may or may not conform with standard representations. Allowing an enterprise to choose how its data is represented without introducing ambiguity or inconsistencies into the HDD would be an advance in the art.

### SUMMARY OF THE INVENTION

These and other problems associated with related art are overcome by the present invention, which is directed towards automating the process of representing data using a health data dictionary. More specifically, the present invention provides a location manager and a representation manager that provide modules that allow the HDD to be manipulated in a manner that allows each separate enterprise or legacy system to represent data using their own terms without affecting the integrity of the HDD.

The inadequacies and shortcomings of previous vocabularies are substantially overcome by the 3M® Healthcare Data Dictionary (HDD). In the HDD, each concept or item is uniquely defined and the HDD is able to incorporate other vocabularies such as ICD and SNOMED into the definitions and descriptions of the unique concepts. In addition, the HDD is able to establish complex relationships between different concepts, which permits meaningful medical expressions to be conveyed. The HDD, in addition to providing a vocabulary for medical data, also provides a vocabulary for other types of data such as demographics, insurance data, pharmaceutical data, physical location data, and the like.

When a legacy system begins to utilize the HDD, the legacy system's data is first mapped to the HDD. This process often includes the creation of concepts and contexts for the legacy system. After the legacy system's initial data has been entered into the HDD, there is often a need to change how the data is represented. Each concept in the HDD has an associated representation and the present invention provides modules that allow the HDD to be modified to more accurately reflect the legacy system's preferred representations. Often these changes are made to interface codes and display texts, which are synonyms to the concepts represented in the HDD. The present invention also allows for changing physical location data in the HDD.

The location manager is used to interact with physical location data and is not permitted to alter other types of data. This provides a legacy system with control over their physical location data without the possibility of changing other data in the HDD. The location manager is often operated by the legacy system because the legacy system is in a position to be more aware of how their physical location data should be identified and represented.

The representation manager is usually not operated by the legacy system. The representation manager provides the ability to interact with many kinds of data. The representation manager facilitates the modification of concept representations, including, but not limited to, searching, moving, inactivating, and activating both representations and contexts.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating the concepts, rules, and knowledge base within a health data dictionary;

FIG. 3 is a block diagram illustrating how data from legacy systems is translated by a health data dictionary and stored in a data repository; and

FIG. 4 is a block diagram illustrating the interaction of a location manager and a representation manager with a health data dictionary.

### DETAILED DESCRIPTION OF THE INVENTION

The present invention relates to systems and methods for translating clinical data and more specifically to systems and methods for managing representations and contexts of the clinical data. A health data dictionary (HDD) is provided that contains concepts, each of which is a unique item or idea. The concepts are grouped according to contexts or domains and are used to translate clinical data. Each concept is associated with a representation that is often specific to a particular entity. The present invention allows these representations to be changed or altered and allows a facility or other entity to also add, change or create physical location data.

The present invention provides the advantages of allowing a facility or other entity to more easily interact with the HDD because each entity can choose relevant representations for their clinical data. This is particularly important with regard to physical location data because hospitals and other facilities are not organized in the same manner. For instance, one hospital can have more beds than another hospital or the nursing divisions can be defined differently. For at least these reasons, it is advantageous for each facility to be able to use entity specific representations for their clinical or physical location data.

As used herein, clinical, medical or patient data refers to data that is associated with a patient and can include, but is not limited to, pharmaceutical data, laboratory results, diagnoses, symptoms, insurance data, personal information, demographic data, physical locations, beds, rooms, nursing divisions, facilities, buildings and the like. Generally, clinical data generated by a legacy system is stored in a general repository, which may be on-site or off-site. The general repository can also be specific to a particular facility or source or used by multiple sources. Before the clinical data is stored in the general repository, it is transmitted through an interface engine to the HDD, where it is mapped, matched, and/or translated. Finally, the processed data is committed to the general repository. The HDD allows codes to be stored with the clinical data such that the clinical data can be consistently retrieved. The present invention therefore extends to both systems and methods for mapping, matching, and translating clinical data as well as to systems and methods for altering the HDD to reflect changes to concept representations and contexts. The embodiments of the present invention may comprise a special purpose or general purpose computer including various computer hardware, as discussed in greater detail below. Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

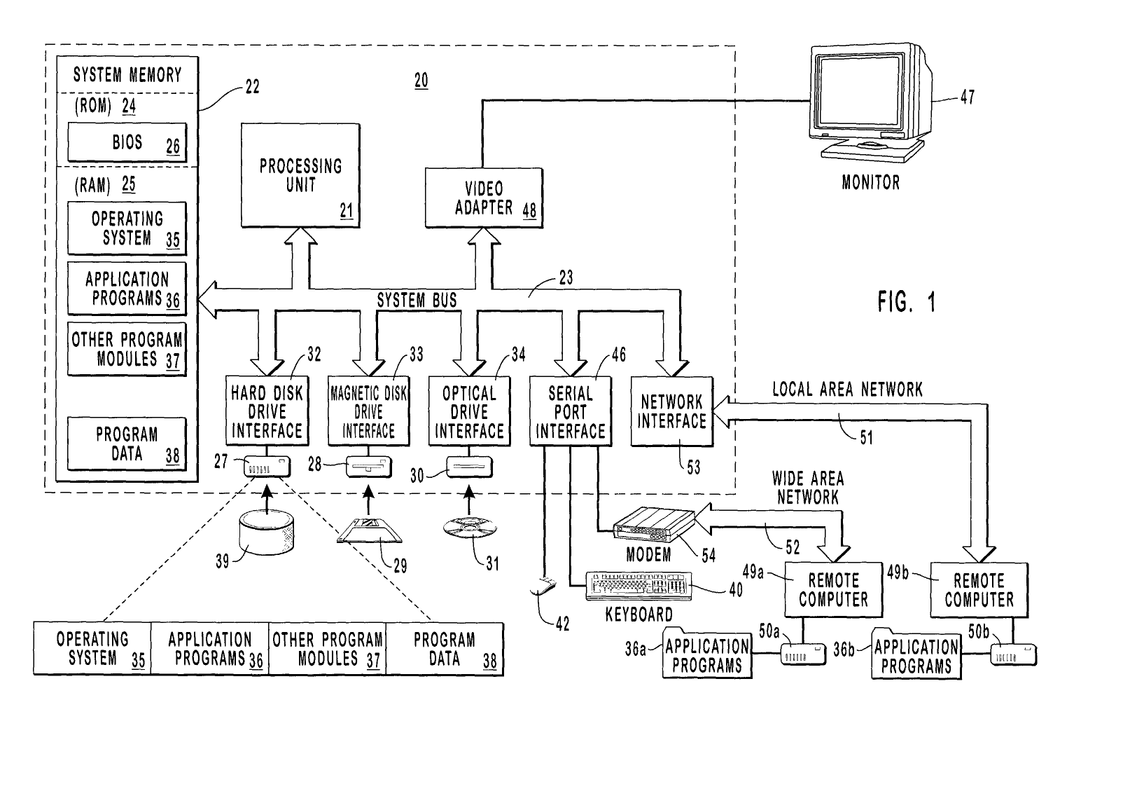

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like. Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

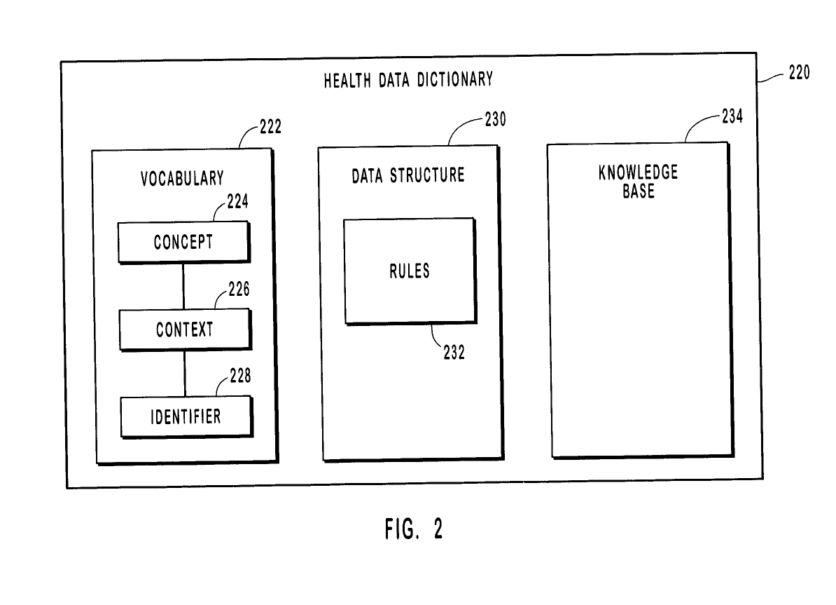

FIG. 2 is a block diagram that illustrates an exemplary health data dictionary (HDD). The HDD 220 describes clinical or medical data in all its possible forms, eliminates data ambiguity, and ensures that data is stored in an appropriate format or vocabulary. The HDD 220 is a database that is used to define or translate the clinical data stored in a computer based patient record (CPR). The HDD 220 ensures that patient data from multiple sources can be integrated and normalized into a form that is accessible by those sources. The HDD 220 integrates a controlled vocabulary, an information model that defines how medical concepts can be combined to produce medical descriptions, and a knowledge base that describes the complex relationships that may exist between the medical concepts.

The vocabulary 222 is designed to identify and uniquely represent concepts. Each concept 224 described within a particular context 226 is assigned a unique identifier 228. For example, the term or concept of “discharge” can occur in several different contexts: A patient can be discharged from a hospital; a surgeon can send a discharge from a wound to a laboratory; a chart can reflect that a discharge from a patient's ears has been occurring for a certain length of time; or a discharge code can be assigned to a particular case.

Another example is the concept represented by the term “cold.” Cold can, refer to body temperature, a feeling, or an upper respiratory infection.

The ambiguity created by these types of terms can be quickly and easily resolved by a care provider or other person because the context is readily apparent to the care provider. It is much more difficult, however, for computers to resolve these types of problems. The HDD 220 overcomes this problem with the vocabulary 222. The vocabulary 222 includes a concept 224, which is a unique, identifiable item or idea. Using the previous example, “cold” can be a concept. In order to make the cold concept unique, it is often provided in a context 226. As used herein, the combination of context and concept is referred to generally as a concept. If cold refers to an upper respiratory infection, then the context may be, for example, a diagnosis. This type of combination of a concept 224 and a context 226 results in unique identifiable items or ideas and each is assigned an identifier 228. In the HDD 220, duplicate concepts or identifiers 228 are not allowed in order to maintain an accurate, controlled vocabulary 222. The HDD 220 is therefore capable of linking vague, ambiguous representations to precise definitions. The context 226 is often referred to as a domain. Examples of domains include, but are not limited to, insurances, diagnoses, symptoms, lab tests, lab results, and the like.

In essence, the vocabulary 222 links surface forms or representations of concepts as they occur in medical language to unique, unambiguous concepts. For example, the representation of “common cold” and the representation of “URI” can both be related to the cold concept that is defined to be an upper respiratory infections. The vocabulary 222 incorporates many different types of surface forms. For example, synonyms, homonyms, and eponyms are related to concepts in the HDD 220. Different representations of the same concept are related in the HDD 220. Thus, expressing a concept using either natural language or SNOMED will be connected to the same unique concept in the HDD 220. Common variants of a term including acronyms and misspellings are integrated into the vocabulary 222. Foreign language equivalents are included in the vocabulary 222 and specific contexts for certain terms are also reflected in the vocabulary. For instance, “dyspnea” may be a surface form for cardiologists while “shortness of breath” may be the preferred surface form for nursing station personnel.

The HDD 220 uses relationship tables to create these complex relationships. In one embodiment, the HDD 220 simply stores identifiers in the relationship tables, which are used to map or translate data as will be described in more detail below. The surface forms or representations are expressed in tables that effectively map surface forms to specific unique concepts. It is therefore possible for a surface form to be related to more than one concept. In this case, the context is useful in determining which concept is used as previously described.

The data structure 230 is a component of the HDD 220 that provides rules 232 to define how medical concepts are utilized. For example, the isolated concept of cold may be of little value. However, combining the cold concept with other concepts such as other symptoms, can result is a medical description. The concepts which represent symptoms can be combined to describe that a patient feels cold, nauseous, and feverish. In another example, the concepts of chest, x-ray and lung mass can be combined to describe that a chest x-ray shows a lung mass. The rules 232 ensure than meaningful medical descriptions are formed. In other words, concepts such as feverish cannot be combined with an x-ray because an x-ray cannot depict the feverish concept. The rules 232 can be altered as needed to ensure that accurate medical descriptions are obtained from the HDD 220.

The knowledge base 234 of the HDD 220 is used to describe the relationships that exist between the concepts in the HDD 220. For example, a lung mass bay be caused by lung cancer. In one embodiment of the HDD 220, the knowledge base 234 exists as related concept tables that link concepts together in defined relationships. The knowledge base 234 may use “is” and “has the components of” relationships to define the related concept tables. For example, the following table represents an exemplary portion of the knowledge base 234.

| Concept (Context) | Relationship | Concept |
|---|---|---|
| Temperature | Is | Cold |
| | | Hot |
| | | Tepid |
| Illness | Has the components of | Symptoms |
| | | Vital signs |
| | | Diagnosis |

Other types of relationships, such as “is a,” “caused by,” “related to,” “relieved by,” and the like can all be expressed and represented in the knowledge base 234. More generally, the HDD 220 is a collection of relationship tables that define concepts, establish relationships, and provide essential information necessary to translate, map and match clinical data contained in CPRs stored in a data repository. When clinical data has been translated and he unique identifiers describing that data are identified, the unique identifiers are often stored in the data repository such that the process can be reversed.

In order to maintain the integrity of the HDD, each different legacy system, organization, facility, or entity maintains a local copy of the HDD. A master version of the HDD is maintained at a different location and the copy of the HDD can be updated as needed. If necessary, changes made to the copy of the HDD can be uploaded to the master version of the HDD if necessary. In certain circumstances, the local copy of the HDD can the alteration is not made to the master version in order to preserve the integrity of the master version. In addition, many local changes are entity-specific and would have no meaning to other entities. For that reason, these types of changes to the HDD are not propagated. In other words, entities maintain copies of the HDD in part because much of the information maintained by the HDD, such as physical location data, is specific to a user and does not need to be stored in the master version of the HDD. If a particular concept is not found in the HDD, an error message is sent to the master HDD. The error message is reviewed and a new entry may be created in the HDD, depending on the analysis of the error message. If a new entry is created, the local copy of the HDD is updated such that the event that generated the error message no longer occurs.

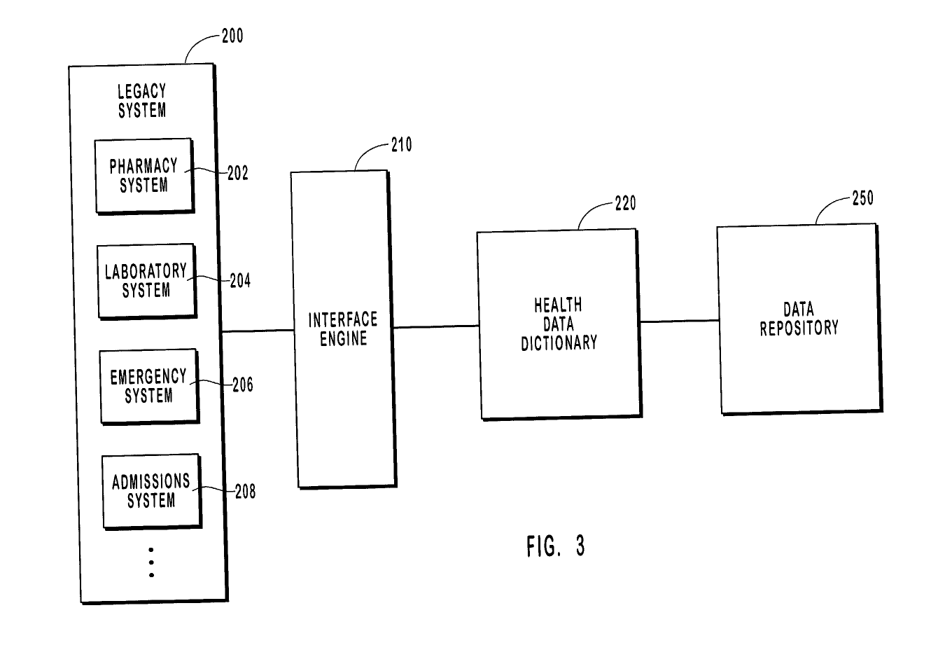

The formation of an extensive computer based patient record (CPR) can potentially involve many different health care providers. Each of these providers obtains different types of information from the patient whose clinical data is stored in the CPR. As previously described, the number of different care providers often causes problems with the CPR because the information gathered by those care providers is in different formats or vocabularies and is not normalized. FIG. 3 is a block diagram that illustrates an exemplary system that uses a health data dictionary to effectively create and store CPRs. The health data dictionary has the significant advantages of providing a data scheme that normalizes patient data and removes ambiguity, returns the patient data to care providers in the appropriate format, and describes medical data in all of its possible forms.

FIG. 3 illustrates a legacy system 200, which is representative of the sources of clinical data including facilities, enterprises, divisions within enterprises, and the like. Exemplary legacy systems include, but are not limited to, pharmacy system 202, laboratory system 204, emergency system 206, and admissions system 208. Each legacy system 200 is used to reflect patient data. The pharmacy system 202, for example, may reflect which drugs have been prescribed for a particular patient as well as the dosage. The laboratory system 204 may describe the results of tests that have been ordered for the patient. The emergency system 206 may reflect the symptoms of a patient as well as a possible diagnosis. The admissions system probably reflects patient data such as name, address, insurance carrier, and the like. In addition, the patient gathered by these legacy systems 200 may overlap in some instances. Other systems may also be used to gather patient information.

Each legacy system transmits data through an interface engine 210. In some instances, the interface engine 210 is not required because the legacy system is a direct client of the HDD. The interface engine 210 generates an interface code that is used when the HDD 220 processes the clinical data provided by the legacy system 200. For example, if the laboratory system 204 is sending data that identifies a patient's blood type from a blood test, then the interface code may be “blood type.” Note that while text is used in this discussion, the actual interface code is most likely a computer recognizable alphanumeric string. The HDD 220 receives the interface code and is aware that the interface engine 210 associated with the laboratory system 204 sent the clinical data. Based on this context, the HDD 220 is able to use the interface code to find the concept identifiers that represent blood type. In this situation, more than one concept may be needed to accurately reflect the clinical data. A separate concept identifier may be needed to identify the test performed by the laboratory, the actual blood type, and the like. These concept identifiers are then stored in the data repository 250 along with information that identifies the patient. In this manner, the data repository 250 contains a patient's CPR in a standard and normalized form that is consistent with other information stored in the data repository 250 for that patient from other clinical data sources. The data repository 250 therefore contains a complete history of medical events associated with a particular person in a form that allows for efficient use by multiple parties. If the test is retrieved from the data repository 250, the HDD 220 can reverse the process to determine that a blood test was performed as well as provide the results of the blood test in the appropriate format or vocabulary. The HDD 220 therefore serves to translate clinical data into a standard and normalized format. Note that the combination of the unique concepts provides a meaningful medical description.

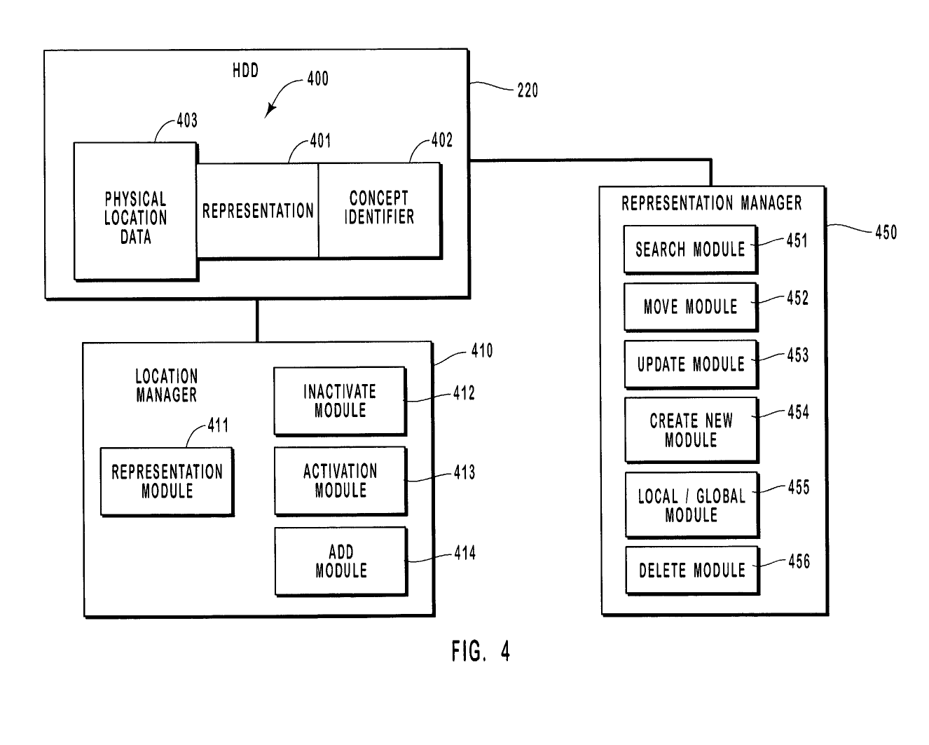

In a similar manner, the HDD can be used to maintain other types of data, such as physical location data. FIG. 4 is a block diagram illustrating tools or modules for working with the HDD. The location manager 410 is shown as connected with the HDD 220 and has the ability to alter the content of the HDD. The location manager 410 can be implemented at a legacy system, at the HDD or other suitable location. The location manager 410 allows a legacy system to have control over and interact with physical location data. Examples of physical location data include, but are not limited to buildings, facilities, laboratories, pharmacies, building wings, nursing divisions, rooms, beds, and the like. In the HDD, data 400 is representative of physical location data. Each unique and identifiable physical location data 403 usually has a corresponding representation 401 and a concept identifier 402. The concept identifier 402 is unique, but can be associated with multiple representations.

The location manager 410 provides several modules that allow the physical location data 400 in the HDD 220 to be more efficiently processed. The representation module 411 is used to change the representation of a particular entry in the HDD 220. Generally, the legacy system determines a current representation of a physical location and provides a new representation for that physical location. When the HDD 220 receives the new representation, the current representation is modified to the new representation without having an effect on the concept identifier. The new representation is then committed to the HDD 220 and the concept identifier is now associated with the new representation.

For example, specific rooms in a hospital often have a name rather than a room number. Assuming that the physical location data 403 corresponds to that room, then the default representation 401 is most likely a number The representation module 411 allows a legacy system to change the representation 401 to another value. In this example, the representation 401 would be changed to the actual name of the room. Importantly, the concept identifier 402 remains unchanged. This feature allows legacy systems to identify physical locations with familiar terms or words without compromising data in the HDD. Also, because the HDD maintains synonym tables, multiple representations can be used for a single concept. Thus, when one person enters information using one representation and another person enters information using a different representation of a single concept, both entries correspond to the correct physical data.

Within the HDD 220, relationships exist between concepts. This is also true with respect to physical location data. For example, the physical location data corresponding to particular birthing rooms is often related to the nursing division of obstetrics. Birthing rooms may also be related to the nursery and more specifically to a particular crib in the nursery. The inactivate module 412 and the activate module 413 permit a legacy system to respectively inactivate and activate a location or a concept. When a particular location is inactivated, the corresponding relationships are deleted through the inactivate module 412. When a location is activated, the corresponding relationships are added to the HDD 220 by the activate module 413. The addition of relationships will conform to all rules and constraints associated with the HDD 220.

As previously described, a legacy system often communicates with the HDD 220 through an interface engine (shown in FIG. 3). The addition or deletion of concepts within the HDD 220 also has an effect on the interface code. In the case of additions to the HDD, an interface code is created. Referring back to FIG. 4, this is accomplished in part through the addition module 414. The addition module 414 allows for new concepts and all of the content associated with the new concept to be added to the HDD 220. For example, when a new bed is added to a room, a user will enter at least information that may include: facility; interface code; nursing division; room; and bed. Other relationships with this data will either be supplied or may be created. The location manager 410 checks all of the physical location data for redundancy and completeness when actions are performed by these modules. The location manager can utilize other modules that perform other functions, such as scheduling representation updates and relationship updates.

FIG. 4 also illustrates a representation manager 450. When a legacy system initially begins to use the HDD 220, it is necessary to map the legacy system's data to the 220. After the initial mapping, it often necessary to edit interface codes, concept representations, and the like. The representation manager 450 provides modules that facilitate this process. The representation manager 450 facilitates searching for representations in different contexts, domains and enterprises or facilities. The searching ability is usually an integral part of the ability of the representation manager 450 to move, update, change, inactivate, etc., the representations of particular concepts stored in the HDD 220. More generally, the representation manager 450 allows: representations to be searched, representations to be moved, representations and contexts to be updated, contexts to be inactivated, representations to be created for concepts, representations to be made either local or global, additional contexts to be added to representations, representations and contexts to be added, and contexts to be deleted.

The search module 451 allows representations stored in the HDD 220 to be searched. The search can be performed using a variety of different techniques including but not limited to, case sensitive searches, partial match searches, wildcard match searches, restricted searches by context, domain and/or facility, and the like. These techniques are examples of steps for searching the health data dictionary for current representations of existing concepts. With the search module 451, the representation manager is able to reduce redundancy and maintain the integrity of the stored data. Searches can be performed across domains and contexts as well as within a particular domain or context of the HDD.

The move module 452 superficially permits a representation for one, concept to be moved to another concept. Actually, the move module 452 identifies an existing concept and a new concept that is to receive the representation of the existing concept. The representation of the existing concept is inactivated and a new representation for the new concept is created by replicating the inactivated representation. This includes replicating associated relationships and affected identifiers.

The update module 453 permits a representation to be updated or changed to another value. The create new module 454 will inactivate a context of a particular concept and allow a new representation and context to be created for the particular concept. The local/global module 455 allows a representation that is specific to a legacy system become specific to more than one legacy system. The local/global module 455 also allows a global representation that is specific to multiple legacy systems to become specific to fewer legacy systems. The delete module 456 does not delete the representations, rather the delete module 456 is used to delete a context associated with a representation. A context is used to determine how a particular concept is represented as compared with a representation, which are used by enterprises to represent concepts.

The functions provided by the modules of the representation manager 450 are effectively instructions to the HDD and when a module is executing, the HDD is effectively receiving instructions from the legacy system. The changes effected in the HDD by the various modules of the representation manager 450 are examples of managing current representations of the concepts stored in the HDD.

When interacting with the HDD 220, both the location manager 410 and the representation manager 450 are constrained by existing HDD constraints, which are in place to ensure that the data in the HDD is not corrupted or made inaccurate.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system including a legacy system sending clinical data including physical location data to a data repository, wherein the clinical data is processed with a health data dictionary before storing the clinical data in the data repository and wherein the physical location data has a representation stored in the health data dictionary, a method for managing the physical location data, the method comprising:
an act of selecting physical location data at the legacy system;
an act of changing a current representation of the selected physical location data to a new representation of the selected physical location data, the current representation stored in the health data dictionary; and
an act of committing the new representation of the physical location data in the health data dictionary.

2. A method as defined in claim 1, wherein the act of changing a current representation of the selected physical location data further comprises an act of updating the current representation to the new representation.

3. A method as defined in claim 1, wherein the act of changing a current representation of the selected physical location data further comprises:
an act of inactivating the selected physical location data; and
an act of deleting relationships of the selected physical location data in the health data dictionary.

4. A method as defined in claim 1, wherein the act of changing a current representation of the selected physical location data further comprises:
an act of activating the selected physical location data; and
an act of inserting relationships of the selected physical location data for the selected physical location data.

5. A method as defined in claim 1, wherein the act of selecting physical location data comprises the act of selecting multiple instances of physical location data.

6. A method as defined in claim 5, further comprising the act of changing a current representation of the multiple instances of physical location data.

7. A method as defined in claim 1, wherein the act of changing a current representation of the selected physical location data further comprises an act of creating an entry for new physical location data in the health data dictionary.

8. A method as defined in claim 1, wherein the act of changing a current representation of the selected physical location data further comprises an act of changing a context of the selected physical location data.

9. A method as defined in claim 1, further comprising an act of checking the physical location data stored in the health data dictionary for redundancies.

10. A method as defined in claim 1, further comprising as act of enforcing rules of the health data dictionary when performing the act of changing a current representation of the selected physical location data.

11. A method as defined in claim 1, wherein the physical location data is one of: an enterprise, a facility, a legacy system, a nursing division, a room, a building, a bed, and a wing of a building.

12. A computer program product having computer executable instructions for executing the acts of claim 1.

13. In a system including a legacy system generating clinical data including physical location data for storage in a data repository, wherein the clinical data is processed using a health data dictionary to translate and normalize the clinical data before storing the clinical data in the data repository, wherein the health data dictionary has content for translating and normalizing the clinical data, the content including a plurality of concept identifiers and at least one representation for each concept, a method for modifying the content of the health data dictionary by the legacy system, the method comprising:
a step for determining a current representation of current physical location data stored in the health data dictionary;
a step for receiving input from the legacy system that identifies a new representation for the current physical location data;
a step for modifying the current representation to the new representation without affecting a concept identifier associated with the current representation;
a step for committing the new representation to the health data dictionary.

14. A method as defined in claim 13, wherein the step for determining a current representation further comprises an act of selecting the current representation from a list of available representations.

15. A method as defined in claim 13, further comprising a step for checking the representations stored in the health data dictionary for redundancies.

16. A method as defined in claim 13, wherein the step for modifying the current representation further comprises at least one of:
an act of updating the current representation with the new representation; and
an act of updating a context of the current representation.

17. A method as defined in claim 13, wherein the step for modifying the current representation further comprises:
a step for inactivating the current representation; and
a step for deleting relationships of the current representation in the health data dictionary.

18. A method as defined in claim 13, wherein the step for modifying the current representation further comprises:
a step for activating a current representation; and
a step for inserting relationships for the current representation in the health data dictionary.

19. A method as defined in claim 13, further comprising a step for modifying interface codes sent to the health data dictionary by the legacy system, wherein the interface codes are used to identify particular concepts in the health data dictionary.

20. A computer program product having computer executable instructions for performing the steps recited in claim 13.

21. In a system including a legacy system having clinical data for storing in a data repository, the clinical data being mapped with a health data dictionary, the health data dictionary having a vocabulary including concept identifiers associated with at least one representations, the concept identifiers and associated at least one representations used to map the clinical data, a method for managing the at least one representations in the health data dictionary, the method comprising:
an act of receiving a current representation from the legacy system, wherein the current representation is associated with an interface code provided by the legacy system;
an act of searching the health data dictionary for the current representation, wherein the current representation is associated with a concept identifier; and
an act of changing the current representation without changing the concept identifier.

22. A method as defined in claim 21, wherein the act of changing the current representation further comprises:
an act of identifying a new concept in the health data dictionary;
an act of inactivating a current concept associated with the current representation; and
an act of applying the current representation to the new concept.

23. A method as defined in claim 21, wherein the act of changing the current representation further comprises an act of updating the current representation to a new representation, the new representation supplied by the legacy system.

24. A method as defined in claim 21, wherein the act of changing the current representation further comprises:
an act of identifying additional representations associated with the same concept as the current representation; and
an act of inactivating the current representation and the additional representations.

25. A method as defined in claim 21, wherein the act of changing the current representation further comprises an act of making the current representation a global representation for use by more than one legacy system.

26. A method as defined in claim 21, wherein the act of changing the current representation further comprises an act of making the current representation a local representation for use by a single legacy system.

27. A method as defined in claim 21, further comprising an act of adding a new representation to the health data dictionary, wherein the new representation is associated with the same concept as the current representation.

28. A method as defined in claim 21, wherein the act of changing the current representation further comprises an act of deleting a context associated with the current representation.

29. A computer program product having computer executable instructions for performing the acts recited in claim 21.

30. In a system including a health data dictionary for mapping clinical data received from a legacy system for storage in a data repository, a method for mapping representations of the clinical data to the health data dictionary, the representations provided by the legacy system, the method comprising:
a step for receiving a current representation identified by the legacy system;
a step for searching the health data dictionary for the current representation;
a step for receiving instructions from the legacy system; and
a step for managing the current representation in accordance with the received instructions such that the current representation is mapped to the clinical data.

31. A method as defined in claim 30, wherein the step for receiving instructions further comprises at least one of:
a step for associating the current representation with a different concept;
a step for updating the current representation and a current context;
a step for inactivating the current representation;
a step for creating a new representation for a current concept;
a step for changing the current representation to a global representation;
a step for changing the current representation to a local representation;
a step for adding a new representation and a new context; and
a step for deleting a context.

32. A method as defined in claim 30, further comprising a step for enforcing rules of the health data dictionary when performing the step of managing the current representation in accordance with the received instructions.

33. A computer program product having computer executable instructions for performing the steps recited in claim 30.
